(19) United States
(12) Patent Application Publication
(10) Pub. No.: US 2021/0023730 A1
(43) Pub. Date: Jan. 28, 2021

(54) Culinary Leaf Shredder Apparatus

(71) Applicant: Margaret Milton, Kathleen, GA (US)

(72) Inventor: Margaret Milton, Kathleen, GA (US)

(21) Appl. No.: 16/520,057

(22) Filed: Jul. 23, 2019

(51) Int. Cl. B26D 3/26; B02C 18/26

(52) U.S. Cl. CPC B26D 3/26; B02C 18/26

(57) ABSTRACT

A culinary leaf shredder apparatus for cutting leaves such as collard greens includes a receptacle and a housing with a housing cavity. The housing has a feed slot and a dispense slot extending through to the housing cavity. A pair of rotor axles is coupled to within the housing cavity and a pair of rotors is coupled to the rotor axles. A plurality of shredder tangs is coupled to the pair of rotors. The plurality of shredder tangs intertwine beneath the feed slot to shred leaves and pass them through the dispense slot. A drive mechanism is coupled to the pair of rotors. A motor is coupled within the housing cavity and is in operational communication with the drive mechanism. A control panel is coupled to the housing and is in operational communication with the motor and a power source.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to culinary tools and more particularly pertains to a new culinary tool for cutting leaves such as collard greens.

### (h) BRIEF SUMMARY OF THE INVENTION

An embodiment of the disclosure meets the needs presented above by generally comprising a receptacle having an open receptacle top side, a receptacle bottom side, and a receptacle sidewall defining a receptacle inside. A housing is coupled to the receptacle. The housing has a housing front side separated from a housing back side, a housing left side separated from a housing right side, and a housing top side separated from a housing bottom side defining a housing cavity. The housing bottom side is selectively engageable with the receptacle top side. The housing top side has a feed slot extending through to the housing cavity and the housing bottom side has a dispense slot extending through to the housing cavity beneath the feed slot. A pair of rotor axles is coupled to the housing. The pair of rotor axles rotatingly extend from a left rotor end support proximal the housing left side to a right rotor end support proximal the housing right side within the housing cavity. The pair of rotor axles comprises a front axle coupled between the housing front side and the feed slot and a back axle coupled between the feed slot and the housing back side. A pair of rotors is coupled to the pair of rotor axles. The pair of rotors comprises a front rotor and a back rotor coupled to the front axle and the back axle, respectively. A plurality of shredder tangs is coupled to the pair of rotors. The plurality of shredder tangs of the front rotor and the back rotor intertwine beneath the feed slot. A drive mechanism is coupled to the pair of rotors. A motor is coupled to the housing. The motor is coupled within the housing cavity and is in operational communication with the drive mechanism. A power source is coupled to the housing and is in operational communication with the motor. A control panel is coupled to the housing top side and is in operational communication with the motor and the power source.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a culinary leaf shredder apparatus according to an embodiment of the disclosure.

FIG. 2 is a top plan view of an embodiment of the disclosure.

FIG. 3 is a bottom plan view of an embodiment of the disclosure.

FIG. 4 is a cross section view along the line 4-4 of an embodiment of the disclosure.

FIG. 5 is an in-use view of an embodiment of the disclosure.

### (j) DETAILED DESCRIPTION OF THE INVENTION

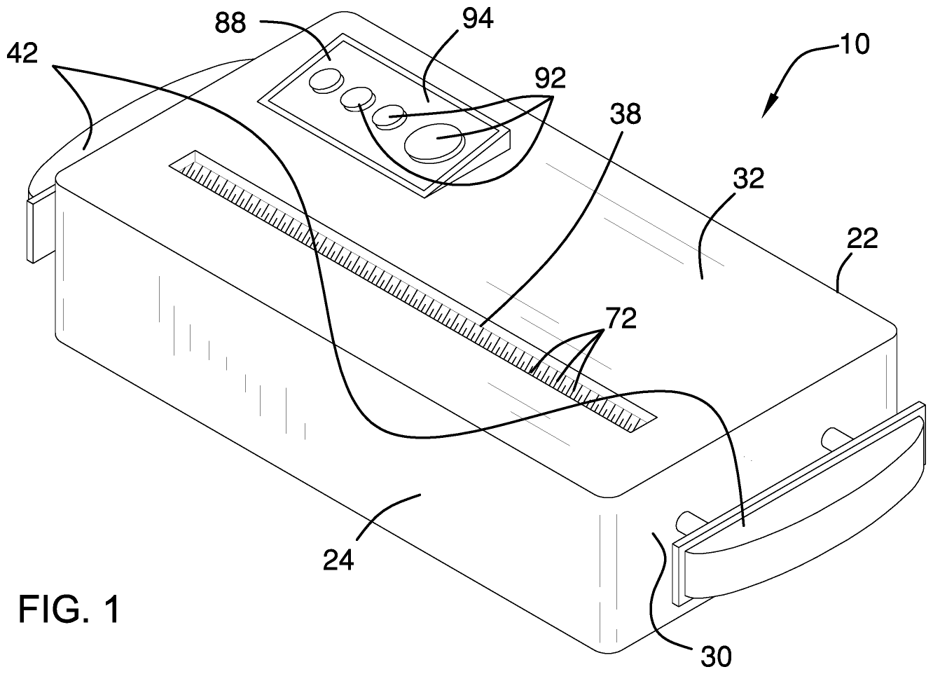

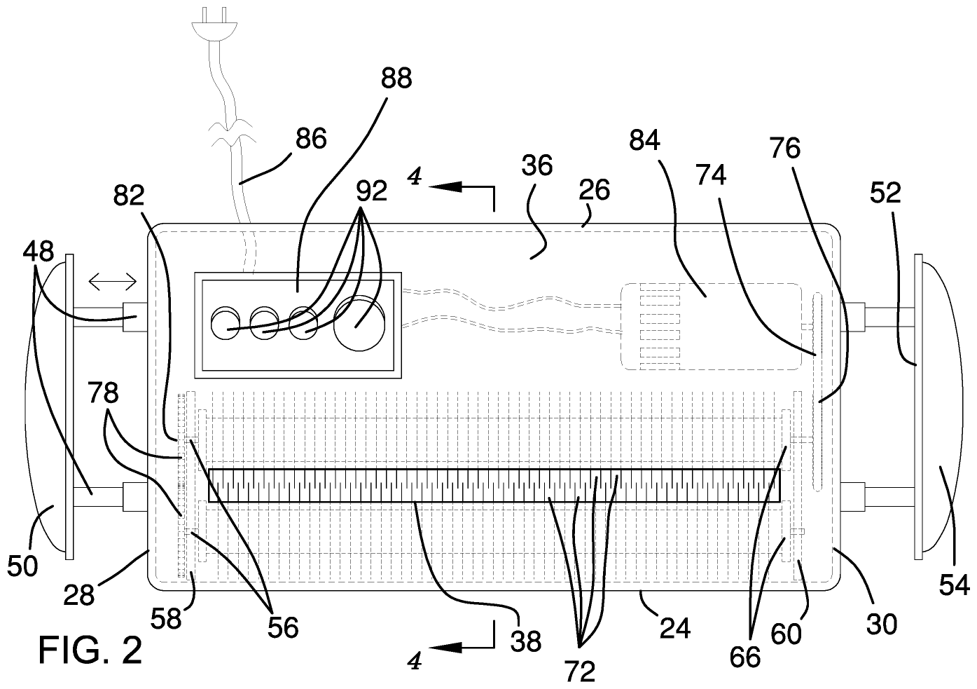

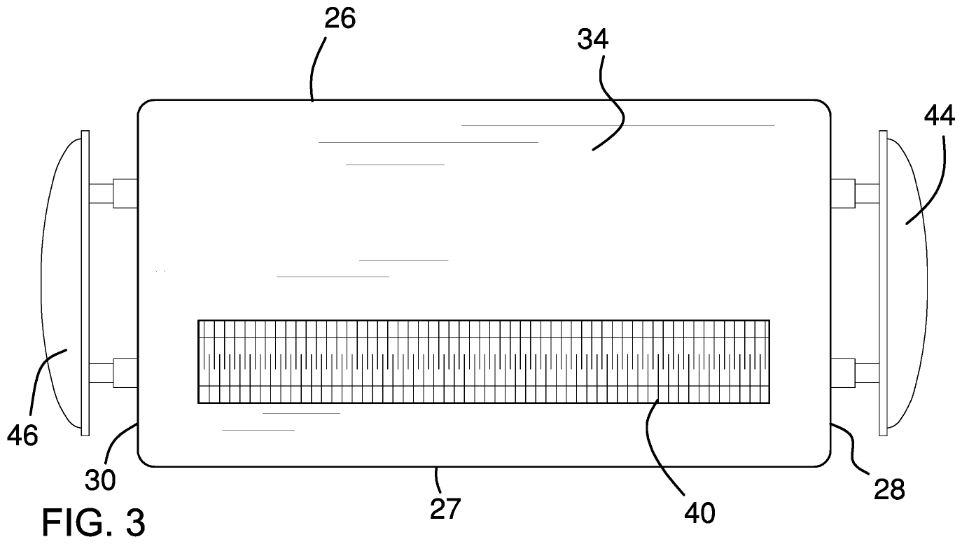

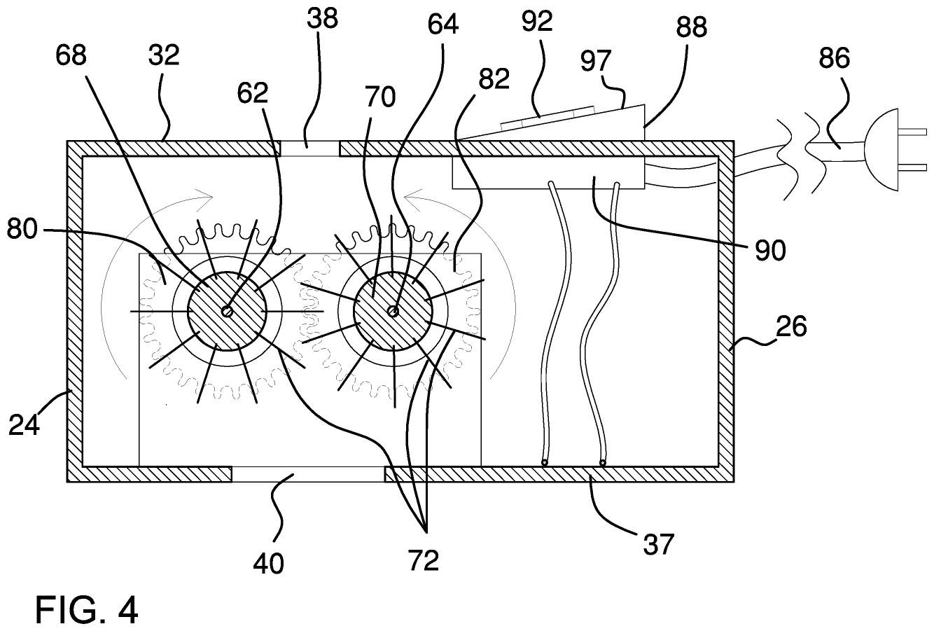

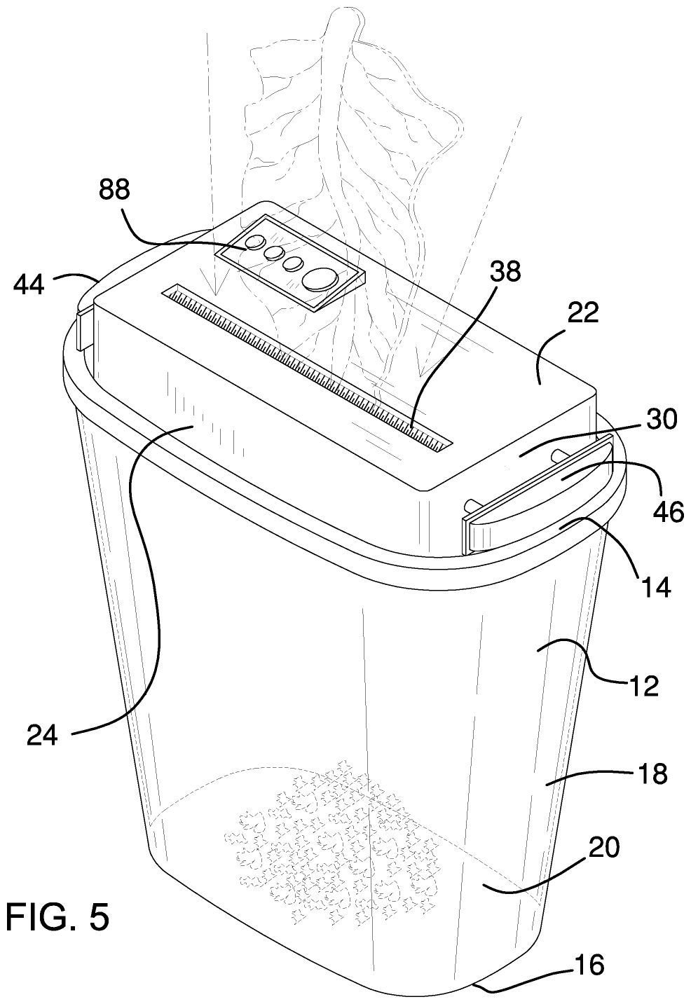

With reference now to the drawings, and in particular to FIGS. 1 through 5 thereof, a new culinary tool embodying the principles and concepts of an embodiment of the disclosure and generally designated by the reference numeral 10 will be described.

As best illustrated in FIGS. 1 through 5, the culinary leaf shredder apparatus 10 generally comprises a receptacle 12 having an open receptacle top side 14, a receptacle bottom side 16, and a receptacle sidewall 18 defining a receptacle inside 20. A housing 22 has a housing front side 24 separated from a housing back side 26, a housing left side 28 separated from a housing right side 30, and a housing top side 32 separated from a housing bottom side 34 defining a housing cavity 36. The housing top side 32 has a feed slot 38 extending through to the housing cavity 36 and the housing bottom side 34 has a dispense slot 40 extending through to the housing cavity 36 beneath the feed slot 38. A width of the dispense slot 40 is greater than a width of the feed slot 38. A pair of supports 42 is coupled to the housing 22. The pair of supports 42 comprises a left support 44 and a right support 46 coupled to the housing left side 28 and the housing right side 30, respectively. The pair of supports 42 is selectively engageable with the receptacle top side 14 to support the housing 22. Each of the pair of supports 42 comprises a pair of arms 48 coupled to the housing 22 and a handle 50 coupled to the pair of arms 48. The handle 50 has a rectangular base 52 coupled to the pair of arms 48 and a curved grip extension 54 coupled to the base 52. Each of the arms 48 is telescopable.

A pair of rotor axles 56 is coupled to the housing 22. The pair of rotor axles 56 rotatingly extend from a left rotor end support 58 proximal the housing left side 28 to a right rotor end support 60 proximal the housing right side 30 within the housing cavity 36. The pair of rotor axles 56 comprises a front axle 62 coupled between the housing front side 24 and the feed slot 38 and a back axle 64 coupled between the feed slot 38 and the housing back side 26. A pair of rotors 66 is coupled to the pair of rotor axles 56. The pair of rotors 66 comprises a front rotor 68 and a back rotor 70 coupled to the front axle 62 and the back axle 64, respectively. A plurality of shredder tangs 72 is coupled to the pair of rotors 66. The plurality of shredder tangs 72 of the front rotor 68 and the back rotor 70 intertwine beneath the feed slot 38 such that they overlap but do not contact. A drive mechanism 74 is coupled to the pair of rotors 66 and comprises a drive pulley 76 coupled to the pair of rotors 66. The drive pulley 76 is coupled to the back axle 64. A pair of drive gears 78 is coupled to the pair of axles 56. The pair of drive gears 78 comprises a front gear 80 and a back gear 82 coupled to the front axle 62 and the back axle 64, respectively. The front gear 80 and the back gear 82 are in operational communication to drive the rotors 66 in opposite directions when the drive pulley 76 spins the back axle 64. A motor 84 is coupled within the housing cavity 36 and is in operational communication with the drive pulley 76. A power source 86 is coupled to the housing 22 and is in operational communication with the motor 84. A control panel 88 is coupled to the housing 22 and comprises a panel box 90 and a plurality of buttons 92. The panel box 90 extends through the housing top side 32 and the plurality of buttons 92 is coupled to a panel top face 94. The panel top face 94 lies in a plane forming an angle with a plane of the housing top side 32. The plurality of buttons 92 is in operational communication with the motor 84 and the power source 86.

In use, the user feeds a vegetable through the feed slot 38 and the motor 84 powers the drive pulley 76 and spins the pair of axles 56 to enable the shredder tangs 72 to shred the vegetable. The plurality of buttons 92 may be used to engage and alternatively disengage the motor 84 as well as to change the direction of the pair of rotors 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A culinary leaf shredder apparatus comprising:
a receptacle having an open receptacle top side, a receptacle bottom side, and a receptacle sidewall defining a receptacle inside;
a housing coupled to the receptacle, the housing having a housing front side separated from a housing back side, a housing left side separated from a housing right side, and a housing top side separated from a housing bottom side defining a housing cavity, the housing bottom side being selectively engageable with the receptacle top side; the housing top side having a feed slot extending through to the housing cavity and the housing bottom side having a dispense slot extending through to the housing cavity beneath the feed slot;
a pair of rotor axles coupled to the housing, the pair of rotor axles rotatingly extending from a left rotor end support proximal the housing left side to a right rotor end support proximal the housing right side within the housing cavity, the pair of rotor axles comprising a front axle coupled between the housing front side and the feed slot and a back axle coupled between the feed slot and the housing back side;
a pair of rotors coupled to the pair of rotor axles, the pair of rotors comprising a front rotor and a back rotor coupled to the front axle and the back axle, respectively;
a plurality of shredder tangs coupled to the pair of rotors, the plurality of shredder tangs of the front rotor and the back rotor intertwining beneath the feed slot;
a drive mechanism coupled to the pair of rotors;
a motor coupled to the housing, the motor being coupled within the housing cavity and in operational communication with the drive mechanism;
a power source coupled to the housing, the power source being in operational communication with the motor; and
a control panel coupled to the housing, the control panel being coupled to the housing top side and being in operational communication with the motor and the power source.

2. The culinary leaf shredder apparatus of claim 1 further comprising the drive mechanism comprising:
a drive pulley coupled to the pair of rotors, the drive pulley being coupled to the back axle; and
a pair of drive gears coupled to the pair of axles, the pair of drive gears comprising a front gear and a back gear coupled to the front axle and the back axle, respectively, the front gear and the back gear being in operational communication to drive the rotors in opposite directions when the drive pulley spins the back axle;

3. The culinary leaf shredder apparatus of claim 1 further comprising a width of the dispense slot being greater than a width of the feed slot.

4. The culinary leaf shredder apparatus of claim 1 further comprising a pair of supports coupled to the housing, the pair of supports comprising a left support and a right support coupled to the housing left side and the housing right side, respectively, the pair of supports being selectively engageable with the receptacle top side to support the housing.

5. The culinary leaf shredder apparatus of claim 4 further comprising each of the pair of supports comprising a pair of arms coupled to the housing and a handle coupled to the pair of arms.

6. The culinary leaf shredder apparatus of claim 5 further comprising the handle having a rectangular base coupled to the pair of arms and a curved grip extension coupled to the base, each of the arms being telescopable.

7. The culinary leaf shredder apparatus of claim 1 further comprising the control panel comprising a panel box and a plurality of buttons, the panel box extending through the housing top side and the plurality of buttons being coupled to a panel top face, the panel top face lying in a plane forming an angle with a plane of the housing top side.

8. A culinary leaf shredder apparatus comprising:
a receptacle having an open receptacle top side, a receptacle bottom side, and a receptacle sidewall defining a receptacle inside;
a housing, the housing having a housing front side separated from a housing back side, a housing left side separated from a housing right side, and a housing top side separated from a housing bottom side defining a housing cavity, the housing top side having a feed slot extending through to the housing cavity and the housing bottom side having a dispense slot extending through to the housing cavity beneath the feed slot, a width of the dispense slot being greater than a width of the feed slot;
a pair of supports coupled to the housing, the pair of supports comprising a left support and a right support coupled to the housing left side and the housing right side, respectively, the pair of supports being selectively engageable with the receptacle top side to support the housing, each of the pair of supports comprising a pair of arms coupled to the housing and a handle coupled to the pair of arms, the handle having a rectangular base coupled to the pair of arms and a curved grip extension coupled to the base, each of the arms being telescopable;
a pair of rotor axles coupled to the housing, the pair of rotor axles rotatingly extending from a left rotor end support proximal the housing left side to a right rotor end support proximal the housing right side within the housing cavity, the pair of rotor axles comprising a front axle coupled between the housing front side and the feed slot and a back axle coupled between the feed slot and the housing back side;
a pair of rotors coupled to the pair of rotor axles, the pair of rotors comprising a front rotor and a back rotor coupled to the front axle and the back axle, respectively;
a plurality of shredder tangs coupled to the pair of rotors, the plurality of shredder tangs of the front rotor and the back rotor intertwining beneath the feed slot;
a drive mechanism coupled to the pair of rotors, the drive mechanism comprising:
a drive pulley coupled to the pair of rotors, the drive pulley being coupled to the back axle; and
a pair of drive gears coupled to the pair of axles, the pair of drive gears comprising a front gear and a back gear coupled to the front axle and the back axle, respectively, the front gear and the back gear being in operational communication to drive the rotors in opposite directions when the drive pulley spins the back axle;
a motor coupled to the housing, the motor being coupled within the housing cavity and in operational communication with the drive pulley;
a power source coupled to the housing, the power source being in operational communication with the motor; and
a control panel coupled to the housing, the control panel comprising a panel box and a plurality of buttons, the panel box extending through the housing top side and the plurality of buttons being coupled to a panel top face, the panel top face lying in a plane forming an angle with a plane of the housing top side, the plurality of buttons being in operational communication with the motor and the power source.
